(19) United States
(12) Patent Application Publication
(10) Pub. No.: US 2006/0111320 A1
(43) Pub. Date: May 25, 2006

(54) Fungicidal mixtures based on a triazolopyrimidine derivative and azoles

(76) Inventors: Jordi Tormo I Blasco, Laudenbach (DE); Thomas Grote, Wachenheim (DE); Eberhard Ammermann, Heppenheim (DE); Reinhard Stierl, Freinsheim (DE); Siegfried Strathmann, Limburgerhof (DE); Ulrich Schofl, Bruhl (DE)

Correspondence Address: BIRCH STEWART KOLASCH & BIRCH, PO BOX 747, FALLS CHURCH, VA, 22040-0747, US

(21) Appl. No.: 10/532,755

(22) PCT Filed: Nov. 14, 2003
(86) PCT No.: PCT/EP03/12767

§ 371 Date: Apr. 27, 2005

(30) Foreign Application Priority Data
Nov. 15, 2002 (DE) 102 53 584.1

(51) Int. Cl. A01N 43/64; A01N 55/00; A01N 43/90; A01N 43/54; A01N 43/50

(52) U.S. Cl. 514/63; 514/259.31; 514/383; 514/400; 514/266.23

(57) ABSTRACT

Disclosed are fungicidal mixtures containing A) a triazolopyrimidine derivative of formula (1), and B) an azole derivative or the salts or addition compound thereof selected among bromuconazole, difenoconazole, diniconazole, fenbuconazole, fluquinconazole, flusilazole, hexaconazole, prochloraz, tetraconazole, triflumizole, flutriafol, myclobutanil, penconazole, simeconazole, ipconazole, triticonazole, and prothioconazole as active components in a synergistically effective quantity, methods for controlling plant-pathogenic fungi by means of mixtures of compounds I and II-XVIII, substances containing said mixtures, and the use of compounds I and II-XVIII for producing such mixtures.

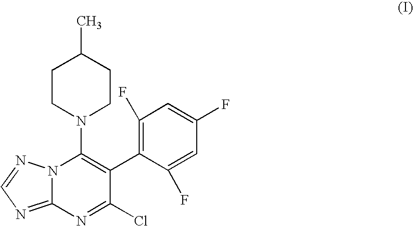

The present invention relates to fungicidal mixtures comprising, as active components,
A) the triazolopyrimidine derivative of the formula I 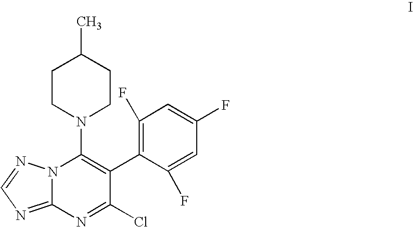
   and
B) an azole derivative or a salt or adduct thereof, selected from the group consisting of
   (1) bromuconazole of the formula II 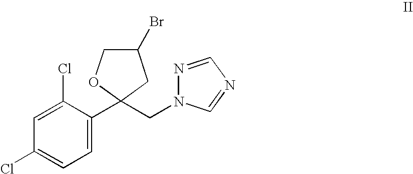
      and
   (2) difenoconazole of the formula III 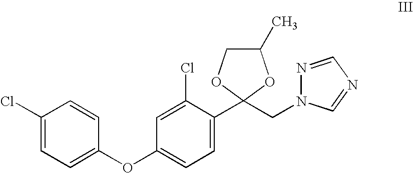
      and
   (3) diniconazole of the formula IV 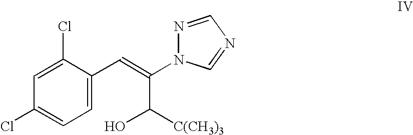
      and
   (4) fenbuconazole of the formula V 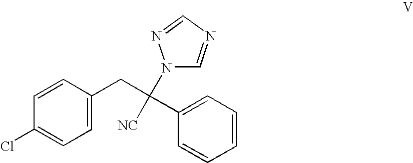
      and
   (5) fluquinconazole of the formula VI 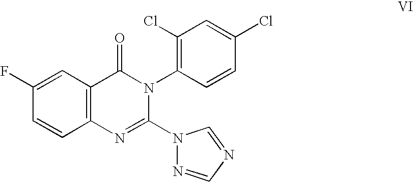
      and
   (6) flusilazole of the formula VII 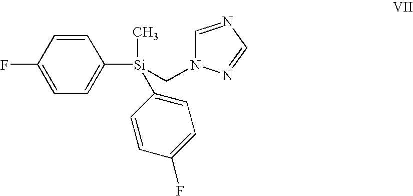
      and
   (7) hexaconazole of the formula VIII 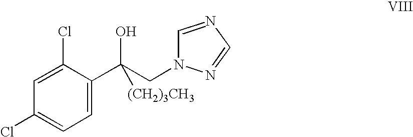
      and
   (8) prochloraz of the formula IX 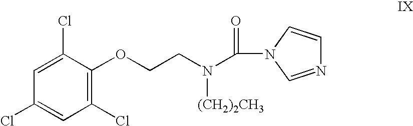
      and
   (9) tetraconazole of the formula X 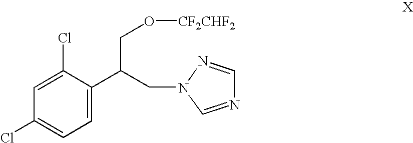
      and
   (10) triflumizole of the formula XI 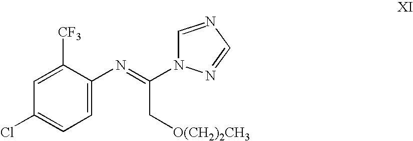
      and
   (11) flutriafol of the formula XII 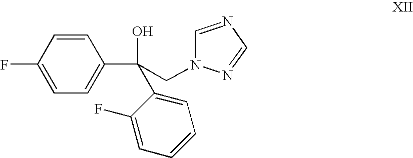
      and
   (12) myclobutanil of the formula XIII 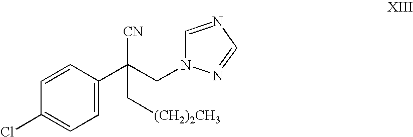
      and
   (13) penconazole of the formula XIV 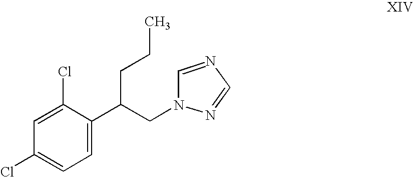
      and
   (14) simeconazole of the formula XV 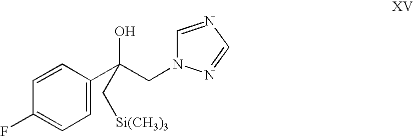
      and
   (15) ipconazole of the formula XVI 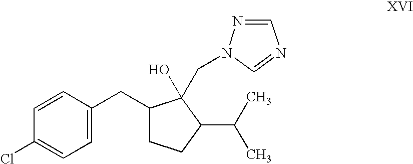
      and
   (16) triticonazole of the formula XVII 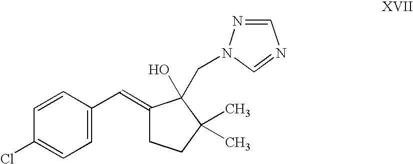
      and
   (17) prothioconazole of the formula XVIII 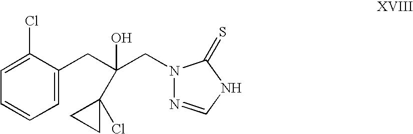
      in a synergistically effective amount.

Moreover, the invention relates to a method for controlling harmful fungi using mixtures of the compound I with at least one of the compounds II to XVIII and to the use of the compound I and at least one of the compounds II to XVIII for preparing such mixtures and to compositions comprising these mixtures.

The compound of the formula I, 5-chloro-7-(4-methylpiperidin-1-yl)-6-(2,4,6-trifluorophenyl)-[1,2,4]triazolo[1,5-a]pyrimidine, its preparation and its action against harmful fungi are known from the literature (WO-A 98/46607).

Mixtures of triazolopyrimidine derivatives with other active compounds are known in a general manner from EP-A 988 790 and U.S. Pat. No. 6,268,371.

The synergistic mixtures of triazolopyrimidines described in EP-A 988 790 are described as being fungicidally active against various diseases of cereals, fruit and vegetables, in particular mildew on wheat and barley or gray mold on apples.

The azole derivatives II to XVIII, their preparation and their action against harmful fungi are known per se:
bromuconazole (II),
1-[4-bromo-2-(2,4-dichlorophenyl)tetrahydrofuran-2-ylmethyl]-1H-[1,2,4]triazole: Proc. Br. Crop Prot. Conf.—Pests Dis., 5-6, 439 (1990);
   difenoconazole (III),
1-{2-[2-chloro-4-(4-chlorophenoxy)phenyl]-4-methyl-[1,3]dioxolan-2-ylmethyl}-1H-[1,2,4∇triazole: GB-A 2 098 607;
   diniconazole (IV),
1-(2,4-dichlorophenyl)-4,4-dimethyl-2-[1,2,4]triazol-1-ylpent-1-en-3-ol: CAS RN [83657-24-3];
   fenbuconazole (V),
3-(4-chlorophenyl)-2-phenyl-2-[1,2,4]triazol-1-ylpropionitrile: EP-A 251 775;
   fluquinconazole (VI),
3-(2,4-dichlorophenyl)-6-fluoro-2-[1,2,4]-triazol-1-yl-3H-quinazolin-4-one: Proc. Br. Crop Prot. Conf.—Pests Dis., 5-3 (1992), 411;
   flusilazole (VII),
1-{[bis(4-fluorophenyl)methylsilanyl]methyl)-1H-[1,2,4]triazole:Proc. Br. Crop Prot. Conf.—Pests Dis., 1 (1984), 413;
   hexaconazole (VIII),
2-(2,4-dichlorophenyl)-1-[1,2,4]triazol-1-ylhexan-2-ol: CAS RN [79983-71-4];
   prochloraz (IX),
N-(propyl-[2-(2,4,6-trichlorophenoxy)ethyl]}imidazole-1-carboxamide: U.S. Pat. No. 3,991,071;
   tetraconazole (X),
1-[2-(2,4-dichlorophenyl)-3-(1,1,2,2-tetrafluoroethoxy)propyl]-1H-[1,2,4]triazole: Proc. Br. Crop Prot. Conf.-Pests Dis., 1 (1988), 49;
   triflumizole (XI),
(4-chloro-2-trifluormethylphenyl)-(2-propoxy-1-[1,2,4]triazol-1-ylethylidene)amine: JP-A 79/119 462;
   flutriafol (XII),
1-(4-fluorophenyl)-1-(2-fluorophenyl)-2-[1,2,4]triazol-1-ylethanol: CAS RN [76674-21-0];
   myclobutanil (XIII),
2-(4-chlorophenyl)-2-[1,2,4]triazol-1-ylmethylpentanenitrile: CAS RN [88671-89-0];
   penconazole (XIV),
1-[2-(2,4-dichlorophenyl)pentyl]-1H-[1,2,4]triazole: Pesticide Manual, 12th Ed. (2000), page 712;
   simeconazole (XV),
1-(4-fluorophenyl)-2-[1,2,4]triazol-1-yl-1-trimethylsilanyl ethanol: The BCPC Conference Pests and Diseases 2000, pp. 557-562;
   ipconazole (XVI),
2-(4-chlorobenzyl)-5-isopropyl-1-[1,2,4]triazol-1-ylmethylcyclo pentanol: EP-A 267 778;
   triticonazole (XVII),
5-(4-chlorobenzylidene)-2,2-dimethyl-1-[1,2,4]triazol-1-ylmethyl cyclopentanol: EP-A 378 953; and
   prothioconazole (XVIII),
2-[2-(1-chlorocyclopropyl)-3-(2-chlorophenyl)-2-hydroxypropyl]-2,4-dihydro[l,2,4]triazole-3-thione: WO 96/16048.

Fungicidal mixtures comprising, as one active compound component, one of the azoles II to XVIII are known from EP-A 531 837, EP-A 645 091 and WO 97/06678.

Practical agricultural experience has shown that the repeated and exclusive application of an individual active compound in the control of harmful fungi leads in many cases to a rapid selection of fungus strains which have developed natural or adapted resistance against the active compound in question. Effective control of these fungi with the active compound in question is then no longer possible.

To reduce the risk of selection of resistant fungus strains, mixtures of different active compounds are nowadays usually employed for controlling harmful fungi. By combining active compounds having different mechanisms of action, it is possible to ensure successful control over a relatively long period of time.

It is an object of the present invention to provide, with a view to effective resistance management and effective control of harmful fungi, further compositions for controlling harmful fungi, in particular for certain indications.

We have found that this object is achieved by mixtures comprising, as active compounds, the triazolopyrimidine derivative of the formula I and, as further fungicidally active component, an active compound from the group consisting of azoles II to XVIII.

Accordingly, the invention provides the mixtures defined at the outset. Moreover, it has been found that simultaneous, that is joint or separate, application of the compounds I and the compounds II or successive application of the compound I and one of the compounds II to XVIII allows better control of harmful fungi than is possible with the individual active compounds alone.

The mixtures according to the invention act synergistically and are therefore particularly suitable for controlling harmful fungi and in particular powdery mildew fungi in cereals, vegetables, fruit, ornamentals and grapevines.

As azole derivative, the mixtures according to the invention comprise at least one compound of formulae II to XVIII.

Even a small proportion of triazolopyrimidine derivative of the formula I is sufficient for the synergistic action to take effect. Triazolopyrimidine derivative and azole are preferably employed in a weight ratio in the range from 100:1 to 1:100, preferably from 20:1 to 1:20, in particular from 10:1 to 1:10.

Owing to the basic character of their nitrogen atoms, the compounds I and II to XVIII are capable of forming salts or adducts with inorganic or organic acids or with metal ions.

Examples of inorganic acids are hydrohalic acids, such as hydrofluoric acid, hydrochloric acid, hydrobromic acid and hydroiodic acid, sulfuric acid, phosphoric acid and nitric acid. Suitable organic acids are, for example, formic acid, carbonic acid and alkanoic acids, such as acetic acid, trifluoroacetic acid, trichloroacetic acid and propionic acid, and also glycolic acid, thiocyanic acid, lactic acid, succinic acid, citric acid, benzoic acid, cinnamic acid, oxalic acid, alkylsulfonic acids (sulfonic acids having straight-chain or branched alkyl radicals of 1 to 20 carbon atoms), arylsulfonic or -disulfonic acids (aromatic radicals, such as phenyl and naphthyl, which carry one or two sulfonic acid groups), alkylphosphonic acids (phosphonic acids having straight-chain or branched alkyl radicals of 1 to 20 carbon atoms), arylphosphonic or -diphosphonic acids (aromatic radicals, such as phenyl or naphthyl, which carry one or two hosphoric acid radicals), where the alkyl or aryl radicals may carry further substituents, for example p-toluenesulfonic acid, salicylic acid, p-aminosalicylic acid, 2-phenoxybenzoic acid, 2-acetoxybenzoic acid, etc.

Suitable metal ions are in particular the ions of the elements of the first to eighth transition group, especially chromium, manganese, iron, cobalt, nickel, copper, zinc, and additionally those of the second main group, especially calcium and magnesium, and of the third and fourth main group, in particular aluminum, tin and lead. If appropriate, the metals can be present in the different valencies that they can assume.

Preference is given to mixtures of the triazolopyrimidine derivative of the formula I with bromuconazole.

Preference is given to mixtures of the triazolopyrimidine derivative of the formula I with difenoconazole.

Preference is given to mixtures of the triazolopyrimidine derivative of the formula I with diniconazole.

Preference is given to mixtures of the triazolopyrimidine derivative of the formula I with fenbuconazole.

Preference is given to mixtures of the triazolopyrimidine derivative of the formula I with fluquinconazole.

Preference is given to mixtures of the triazolopyrimidine derivative of the formula I with flusilazole.

Preference is given to mixtures of the triazolopyrimidine derivative of the formula I with hexaconazole.

Preference is given to mixtures of the triazolopyrimidine derivative of the formula I with prochloraz.

Preference is given to mixtures of the triazolopyrimidine derivative of the formula I with tetraconazole.

Preference is given to mixtures of the triazolopyrimidine derivative of the formula I with triflumizole.

Preference is given to mixtures of the triazolopyrimidine derivative of the formula I with flutriafol.

Preference is given to mixtures of the triazolopyrimidine derivative of the formula I with myclobutanil.

Preference is given to mixtures of the triazolopyrimidine derivative of the formula I with penconazole.

Preference is given to mixtures of the triazolopyrimidine derivative of the formula I with simeconazole.

Preference is given to mixtures of the triazolopyrimidine derivative of the formula I with ipconazole.

Preference is given to mixtures of the triazolopyrimidine derivative of the formula I with triticonazole.

Preference is given to mixtures of the triazolopyrimidine derivative of the formula I with prothioconazole.

When preparing the mixtures, it is preferred to employ the pure active compounds I and II to XVIII, to which further active compounds against harmful fungi or other pests, such as insects, arachnids or nematodes, or else herbicidal or growth-regulating active compounds or fertilizers can be added.

The mixtures of the compounds I and at least one of the compounds II to XVIII, or the compounds I and at least one of the compounds II to XVIII used simultaneously, that is jointly or separately, exhibit outstanding action against a broad spectrum of phytopathogenic fungi, in particular from the class of the Ascomycetes, Basidiomycetes, Phycomycetesand Deuteromycetes. Some of these compounds act systemically and can therefore also be employed as foliar- and soil-acting fungicides.

They are especially important for controlling a large number of fungi on various crop plants, such as cotton, vegetable plants (for example cucumbers, beans, tomatoes, potatoes and cucurbits), barley, grass, oats, bananas, coffee, corn, fruit plants, rice, rye, soybean, grapevine, wheat, ornamentals, sugar cane and a large number of seeds.

They are particularly suitable for controlling the following phytopathogenic fungi: Blumeria graminis (powdery mildew) on cereals, Erysiphe cichoracearum and Sphaerotheca fuliginea on cucurbits, Podosphaera leucotricha on apples, Uncinula necator on grapevines, Puccinia species on cereals, Rhizoctonia species on cotton, rice and grass, Ustilago species on cereals and sugarcane, Venturia inaequalis on apples, Bipolaris and Drechslera species on cereals, rice and grass, Septoria nodorum on wheat, Botrytis cinerea on strawberries, vegetables, ornamentals and grapevines, Mycosphaerella species on bananas, groundnuts and cereals, Pseudocercosporella herpotrichoides on wheat and barley, Pyricularia oryzae on rice, Phytophthora infestans on potatoes and tomatoes, Pseudoperonospora species on cucurbits and hops, Plasmopara viticola on grapevines, Alternaria species on vegetables and fruit, and also Fusarium and Verticillium species.

The mixtures according to the invention are preferably useful for controlling powdery mildew fungi in crops of cereals, grapevines and vegetables and in ornamentals.

In addition, the mixtures according to the invention are preferably also active against harmful fungi from the class of Oomycetes, in particular against Phytophthora infestans in potatoes and tomatoes.

The mixtures according to the invention are preferably also suitable for controlling rice pathogens.

Owing to the special cultivation conditions of rice plants, the requirements that a rice fungicide has to meet are considerably different from those that fungicides used in cereal- or fruit-cultivation have to meet. There are significant differences in modern systems of rice culvitation: in addition to the spray application customary in many countries, in these systems the fungicide is applied directly onto the soil, during or shortly after sowing. The fungicide is taken up into the plant via the roots and transported in the sap of the plant to the plant parts to be protected. For rice fungicides, high systemic action is therefore essential. In contrast, in cereal- or fruit-cultivation, the fungicide is usually applied to the leaves or the fruits; accordingly, in these crops the systemic action of the active compounds is considerably less important.

Moreover, rice pathogens are typically different from those in cereals or fruit. Pyricularia oryzae, Cochliobolus miyabeanus and Corticium sasakii (syn. Rhizoctonia solani) are the pathogens of the diseases most prevalent in rice plants. Rhizoctonia solani is the only pathogen of agricultural significance from the sub-class Agaricomycetidae. In contrast to most other fungi, this fungus attacks the plant not via spores but via a mycelium infection.

For this reason, findings concerning the fungicidal activity in the cultivation of cereals or fruit cannot be transferred to rice crops.

The compound I and at least one of the compounds II to XVIII can be applied simultaneously, that is jointly or separately, or in succession, the sequence, in the case of separate application, generally not having any effect on the result of the control measures.

Depending on the nature of the desired effect, the application rates of the mixtures according to the invention are, especially in the case of agricultural cultivation areas, from 5 to 2000 g/ha, preferably from 50 to 1500 g/ha, in particular from 50 to 750 g/ha.

The application rates of the compound I here are from 1 to 1000 g/ha, preferably from 10 to 900 g/ha, in particular from 20 to 750 g/ha.

Correspondingly, the application rates of the compounds II to XVIII are from 1 to 1000 g/ha, preferably from 10 to 900 g/ha, in particular from 20 to 750 g/ha.

In the treatment of seed, the application rates of the mixture are generally from 1 to 1000 g/100 kg of seed, preferably from 1 to 200 g/100 kg, in particular from 5 to 100 g/100 kg.

In the control of phytopathogenic harmful fungi, the separate or joint application of the compounds I and at least one of the compounds II to XVIII or of the mixtures of the compounds I and at least one of the compounds II to XVIII is carried out by spraying or dusting the seeds, the plants or the soils before or after sowing of the plants or before or after emergence of the plants.

The fungicidal synergistic mixtures according to the invention or the compound I and at least one of the compounds II to XVIII can be prepared, for example, in the form of directly sprayable solutions, powder and suspensions or in the form of highly concentrated aqueous, oily or other suspensions, dispersions, emulsions, oil dispersions, pastes, dusts, compositions for broadcasting or granules, and be applied by spraying, atomizing, dusting, broadcasting or pouring. The application form depends on the particular purpose; in each case, it should ensure fine and uniform distribution of the mixture according to the invention.

The compounds I and II to XVIII, the mixtures or the appropriate formulations are applied by treating the harmful fungi, their habitat or the plants, seeds, soils, areas, materials or spaces to be kept free from them with a fungicidally effective amount of the mixture or of the compounds I and at least one of the compounds II to XVIII in the case of separate application.

Application can precede or follow infection by the harmful fungi.

The formulations are prepared in a known manner, for example by extending the active compound with solvents and/or carriers, if desired using emulsifiers and dispersants. Solvents/auxiliaries which are suitable are essentially:
water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used,
carriers such as ground natural minerals (for example kaolins, clays, talc, chalk) and ground synthetic minerals (for example finely divided silica, silicates); emulsifiers such as nonionic and anionic emulsifiers (for example polyoxyethylene fatty alcohol ethers, alkylsulfonates and arylsulfonates) and dispersants such as lignin-sulfite waste liquors and methylcellulose.

Suitable surfactants are the alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and of naphthalene derivatives with formaldehyde, condensates of naphthalene or of naphthalenesulfonic acid with phenol and formaldehyde, polyoxyethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol/- and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone or water.

Powders, compositions for broadcasting and dusts can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compounds. The active compounds are employed in a purity of from 90% to 100%, preferably 95% to 100% (according to NMR spectrum).

The following are examples of formulations: 1. Products for dilution with water
A) Water-soluble concentrates (SL)
   10 parts by weight of the active compounds are dissolved in water or in a water-soluble solvent. As an alternative, wetters or other auxiliaries are added. The active compound dissolves upon dilution with water.
B) Dispersible concentrates (DC)
   20 parts by weight of the active compounds are dissolved in cyclohexanone with addition of a dispersant, for example polyvinylpyrrolidone. Dilution with water gives a dispersion.
C) Emulsifiable concentrates (EC)
   15 parts by weight of the active compounds are dissolved in xylene with addition of calcium dodecylbenzenesulfonate and castor oil ethoxylate (in each case 5%). Dilution with water gives an emulsion.
D) Emulsions (EW, EO)
   40 parts by weight of the active compounds are dissolved in xylene with addition of calcium dodecylbenzenesulfonate and castor oil ethoxylate (in each case 5%). This mixture is introduced into water by means of an emulsifier (Ultraturax) and made into a homogeneous emulsion. Dilution with water gives an emulsion.
E) Suspensions (SC, OD)
   In an agitated ball mill, 20 parts by weight of the active compounds are comminuted with addition of dispersant, wetters and water or an organic solvent to give a fine active compound suspension. Dilution with water gives a stable suspension of the active compound.
F) Water-dispersible granules and water-soluble granules (WG, SG)
   50 parts by weight of the active compounds are ground finely with addition of dispersants and wetters and made into water-dispersible or water-soluble granules by means of technical appliances (for example extrusion, spray tower, fluidized bed). Dilution with water gives a stable dispersion or solution of the active compound.
G) Water-dispersible powders and water-soluble powders (WP, SP)
   75 parts by weight of the active compounds are ground in a rotor-stator mill with addition of dispersants, wetters and silica gel. Dilution with water gives a stable dispersion or solution of the active compound.
      2. Products to be Applied Undiluted
H) Dustable powders (DP)
   5 parts by weight of the active compounds are ground finely and mixed intimately with 95% of finely divided kaolin. This gives a dust.
I) Granules (GR, FG, GG, MG)
   0.5 part by weight of the active compounds is ground finely and associated with 95.5% carriers. Current methods are extrusion, spray-drying or fluidized bed. This gives granules to be applied undiluted.
J) ULV solutions (UL)
   10 parts by weight of the active compounds are dissolved in an organic solvent, for example xylene. This gives a product to be applied undiluted.

The active compounds can be used as such, in the form of their formulations or the use forms prepared therefrom, for example in the form of directly sprayable solutions, powders, suspensions or dispersions, emulsions, oil dispersions, pastes, dust, compositions for broadcasting, or granules, by means of spraying, atomizing, dusting, broadcasting or pouring. The use forms depend entirely on the intended purposes; it is intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates suitable for dilution with water and composed of active substance, wetter, tackifier, dispersant or emulsifier and, if appropriate, solvent or oil.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), where it is possible to apply formulations comprising over 95% by weight of active compound, or even to apply the active compound without additives.

Oils of various type, wetters, adjuvants, herbicides, fungicides, other pesticides, or bactericides may be added to the active compounds, if appropriate just immediately prior to use (tank ix). These agents are usually admixed with the compositions according to the invention in a weight ratio of 1:10 to 10:1.

### USE EXAMPLES

The synergistic action of the mixtures according to the invention an be demonstrated by the experiments below:

The active compounds, separately or jointly, were prepared as a stock solution with 0.25% by weight of active compound in acetone or DMSO. 1% by weight of the emulsifier Uniperol® EL (wetting agent having emulsifying and dispersing action based on ethoxylated alkylphenols) was added to this solution. The active compounds or the mixtures were diluted with water to the stated concentration.

Evaluation was carried out by determining the infected leaf areas in percent. These percentages were converted into efficacies. The efficacy (W) is calculated as follows using Abbot's formula:
W=(1−α/β)·100
α is the level of fungicidal infection of the treated plants in % and
β is the level of fungicidal infection of the untreated (control) plants in %

An efficacy of 0 means that the infection level of the treated plants corresponds to that of the untreated control plants; an efficacy of 100 means that the treated plants were not infected.

The expected efficacies of the mixtures of active compounds were determined using Colby's formula [R. S. Colby, Weeds 15, 20-22 (1967)] and compared with the observed efficacies.
Colby's formula: E=x+y−x·y/100
E expected efficacy, expressed in % of the untreated control, when using the mixture of the active compounds A and B at the concentrations a and b
x efficacy, expressed in % of the untreated control, when using active compound A at the concentration a
y efficacy, expressed in % of the untreated control, when using active compound B at the concentration b

### Use Example 1

### Protective Activity against Rice Blast caused by Pyricularia oryzae

Leaves of rice seedlings of the cultivar “Tai-Nong 67”, which had been grown in pots, were sprayed to runoff point with an aqueous suspension having the concentration of active compounds stated below. The next day, the plants were inoculated with an aqueous spore suspension of Pyricularia oryzae. The test plants were then placed in climatized chambers at 22-24° C. and 95-99% relative atmospheric humidity for 6 days. The extent of the development of the infection on the leaves was then determined visually.

TABLE A
Individual active compounds

| | | Concentration of | |
|---|---|---|---|
| | | active compound | Efficacy in % of |
| | | in the spray | the untreated |
| Example | Active compound | liquor [ppm] | control |
| 1 | Control | — | (90% infection) |
| | (untreated) | | |
| 2 | I | 4 | 33 |
| | | 1 | 11 |
| | | 0.25 | 0 |
| 3 | V (fenbuconazole) | 1 | 0 |
| 4 | VII (flusilazole) | 1 | 11 |
| 5 | VIII | 1 | 11 |
| | (hexaconazole) | | |
| 6 | XI (triflumizole) | 1 | 11 |
| 7 | XVI (ipconazole) | 1 | 11 |

TABLE B
Mixtures according to the invention

| | Mixture of active | | |
|---|---|---|---|
| | compounds | | |
| | Concentration | Observed | Calculated |
| Example | Mixing ratio | efficacy | efficacy*) |
| 8 | I + V | 67 | 33 |
| | 4 + 1 ppm | | |
| | 4:1 | | |
| 9 | I + V | 56 | 11 |
| | 1 + 1 ppm | | |
| | 1:1 | | |
| 10 | I + V | 44 | 0 |
| | 0.25 + 1 ppm | | |
| | 1:4 | | |
| 11 | I + VII | 78 | 41 |
| | 4 + 1 ppm | | |
| | 4:1 | | |
| 12 | I + VII | 67 | 21 |
| | 1 + 1 ppm | | |
| | 1:1 | | |
| 13 | I + VII | 56 | 11 |
| | 0.25 + 1 ppm | | |
| | 1:4 | | |
| 14 | I + VIII | 67 | 33 |
| | 4 + 1 ppm | | |
| | 4:1 | | |
| 15 | I + VIII | 67 | 11 |
| | 1 + 1 ppm | | |
| | 1:1 | | |
| 16 | I + VIII | 56 | 0 |
| | 0.25 + 1 ppm | | |
| | 1:4 | | |
| 17 | I + XI | 67 | 41 |
| | 4 + 1 ppm | | |
| | 4:1 | | |
| 18 | I + XI | 56 | 21 |
| | 1 + 1 ppm | | |
| | 1:1 | | |
| 19 | I + XI | 44 | 11 |
| | 0.25 + 1 ppm | | |
| | 1:4 | | |
| 20 | I + XVI | 83 | 41 |
| | 4 + 1 ppm | | |
| | 4:1 | | |
| 21 | I + XVI | 67 | 21 |
| | 1 + 1 ppm | | |
| | 1:1 | | |
| 22 | I + XVI | 56 | 11 |
| | 0.25 + 1 ppm | | |
| | 1:4 | | |

*)efficacy calculated using Colby's formula

### Use Example 2

### Activity against Brown Spot of Rice caused by Cochliobolus miyabeanus, Protective Treatment

Leaves of rice seedlings of the cultivar “Tai-Nong 67”, which had been grown in pots, were sprayed to runoff point with an aqueous suspension having the concentration of active compounds stated below. The next day, the plants were inoculated with an aqueous spore suspension of Cochliobolus miyabeanus. The test plants were then placed in climatized chambers at 22-24° C. and 95-99% relative atmospheric humidity for 6 days. The extent of the development of the infection on the leaves was then determined visually.

TABLE C
Individual active compounds

| | | Concentration of | |
|---|---|---|---|
| | | active compound | Efficacy in % of |
| | | in the spray | the untreated |
| Example | Active compound | liquor [ppm] | control |
| 23 | Control | — | (80% Befall) |
| | (untreated) | | |
| 24 | I | 4 | 33 |
| 25 | II (bromuconazole) | 16 | 50 |
| | | 4 | 25 |
| | | 1 | 13 |
| 26 | III | 16 | 63 |
| | (difenoconazole) | 4 | 38 |
| | | 1 | 13 |
| 27 | IV (diniconazole) | 16 | 25 |
| | | 4 | 0 |
| | | 1 | 0 |
| 28 | IX (prochloraz) | 16 | 63 |
| | | 4 | 38 |
| | | 1 | 0 |
| 29 | XII (flutriafol) | 16 | 63 |
| | | 4 | 25 |
| | | 1 | 0 |
| 30 | XIII | 16 | 50 |
| | (myclobutanil) | 4 | 0 |
| | | 1 | 0 |
| 31 | XIV (penconazole) | 16 | 63 |
| | | 4 | 25 |
| | | 1 | 0 |
| 32 | XVIII | 16 | 63 |
| | (prothioconazole) | 4 | 50 |
| | | 1 | 13 |

TABLE D
Mixtures according to the invention

| | Mixture of active | | |
|---|---|---|---|
| | compounds | | |
| | Concentration | Observed | Calculated |
| Example | Mixing ratio | efficacy | efficacy*) |
| 33 | I + II | 50 | 13 |
| | 4 +1 ppm | | |
| | 4:1 | | |
| 34 | I + II | 75 | 25 |
| | 4 + 4 ppm | | |
| | 1:1 | | |
| 35 | I + II | 75 | 50 |
| | 4 + 16 ppm | | |
| | 1:4 | | |
| 36 | I + III | 63 | 13 |
| | 4 + 1 ppm | | |
| | 4:1 | | |
| 37 | I + III | 75 | 38 |
| | 4 + 4 ppm | | |
| | 1:1 | | |
| 38 | I + III | 94 | 63 |
| | 4 + 16 ppm | | |
| | 1:4 | | |
| 39 | I + IV | 50 | 0 |
| | 4 + 1 ppm | | |
| | 4:1 | | |
| 40 | I + IV | 63 | 0 |
| | 4 + 4 ppm | | |
| | 1:1 | | |
| 41 | I + IV | 88 | 25 |
| | 4 + 16 ppm | | |
| | 1:4 | | |
| 42 | I + IX | 63 | 0 |
| | 4 + 1 ppm | | |
| | 4:1 | | |
| 43 | I + IX | 63 | 38 |
| | 4 + 4 ppm | | |
| | 1:1 | | |
| 44 | I + IX | 88 | 63 |
| | 4 + 16 ppm | | |
| | 1:4 | | |
| 45 | I + XII | 50 | 0 |
| | 4 + 1 ppm | | |
| | 4:1 | | |
| 46 | I + XII | 63 | 25 |
| | 4 + 4 ppm | | |
| | 1:1 | | |
| 47 | I + XII | 88 | 63 |
| | 4 + 16 ppm | | |
| | 1:4 | | |
| 48 | I + XIII | 50 | 0 |
| | 4 + 1 ppm | | |
| | 4:1 | | |
| 49 | I + XIII | 69 | 0 |
| | 4 + 4 ppm | | |
| | 1:1 | | |
| 50 | I + XIII | 75 | 50 |
| | 4 + 16 ppm | | |
| | 1:4 | | |
| 51 | I + XIV | 50 | 0 |
| | 4 + 1 ppm | | |
| | 4:1 | | |
| 52 | I + XIV | 63 | 25 |
| | 4 + 4 ppm | | |
| | 1:1 | | |
| 53 | I + XIV | 88 | 63 |
| | 4 + 16 ppm | | |
| | 1:4 | | |
| 54 | I + XVIII | 63 | 13 |
| | 4 + 1 ppm | | |
| | 4:1 | | |
| 55 | I + XVIII | 81 | 50 |
| | 4 + 4 ppm | | |
| | 1:1 | | |
| 56 | I + XVIII | 94 | 63 |
| | 4 + 16 ppm | | |
| | 1:4 | | |

*)efficacy calculated using Colby's formula

### Use Example 3

### Activity Against Peronospora of Grapevines caused by Plasmopara viticola

Leaves of potted vines were sprayed to runoff point with an aqueous suspension having the concentration of active compound stated below. The next day, the undersides of the leaves were inoculated with an aqueous sporangial suspension of Plasmopara viticola. The grapevines were then initially placed into a water-vapor-saturated chamber at 24° C. for 48 hours and then placed in a greenhouse at 20-30° C. for 5 days. After this period of time, the plants were again placed in a humid chamber for 16 hours to promote sporangiophore eruption. The extent to which the infection had developed on the undersides of the leaves was then determined visually.

TABLE E
Individual active compounds

| | | Concentration of | |
|---|---|---|---|
| | | active compound in | Efficacy in % of |
| | | the spray liquor | the untreated |
| Example | Active compound | [ppm] | control |
| 57 | Control | — | (80% infection) |
| | (untreated) | | |
| 58 | I | 4 | 38 |
| | | 1 | 0 |
| 59 | VI | 4 | 0 |
| | (fluquinconazole) | 1 | 0 |
| 60 | X (tetraconazole) | 4 | 0 |
| | | 1 | 0 |
| 61 | XVII | 4 | 0 |
| | (triticonazole) | 1 | 0 |

TABLE F
Mixtures according to the invention

| | Mixture of active | | |
|---|---|---|---|
| | compound | | |
| | Concentration | Observed | Calculated |
| Example | Mixing ratio | efficacy | efficacy*) |
| 62 | I + IV | 63 | 38 |
| | 4 + 1 ppm | | |
| | 4:1 | | |
| 63 | I + IV | 75 | 38 |
| | 4 + 4 ppm | | |
| | 1:1 | | |
| 64 | I + IV | 63 | 0 |
| | 1 + 4 ppm | | |
| | 1:4 | | |
| 65 | I + X | 63 | 38 |
| | 4 + 1 ppm | | |
| | 4:1 | | |
| 66 | I + X | 75 | 38 |
| | 4 + 4 ppm | | |
| | 1:1 | | |
| 67 | I + X | 50 | 0 |
| | 1 + 4 ppm | | |
| | 1:4 | | |
| 68 | I + XVII | 69 | 38 |
| | 4 + 1 ppm | | |
| | 4:1 | | |
| 69 | I + XVII | 75 | 38 |
| | 4 + 4 ppm | | |
| | 1:1 | | |
| 70 | I + XVII | 50 | 0 |
| | 1 + 4 ppm | | |
| | 1:4 | | |

*)efficacy calculated using Colby's formula

The test results show that for all mixing ratios the observed efficacy of the mixtures according to the invention is considerably higher than that preducted using Colby's formula.

1. A fungicidal mixture, comprising, as active components,
A) the triazolopyrimidine derivative of the formula I 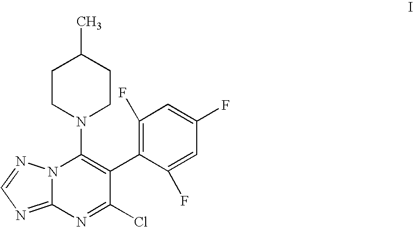
and
B) an azole derivative or a salt or adduct thereof, selected from the group consisting of
(1) bromuconazole of the formula II 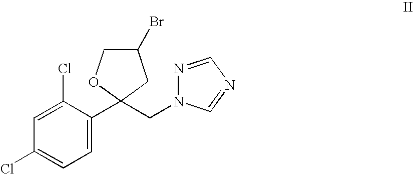
and
(2) difenoconazole of the formula III 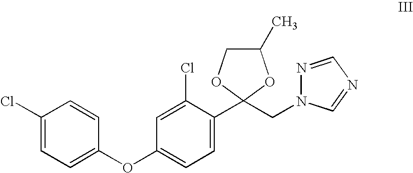
and
(3) diniconazole of the formula IV 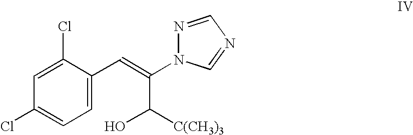
and
(4) fenbuconazole of the formula V 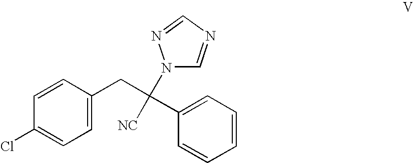
and
(5) fluquinconazole of the formula VI 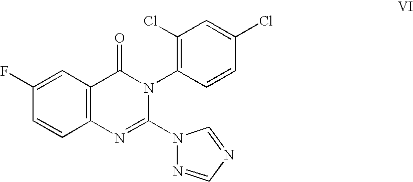
and
(7) flusilazole of the formula VII 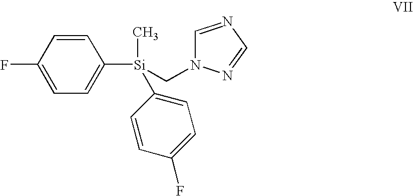
and
(7) hexaconazole of the formula VIII 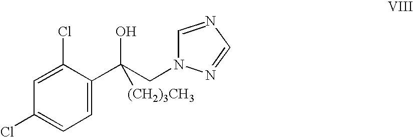
and
(8) prochloraz of the formula IX 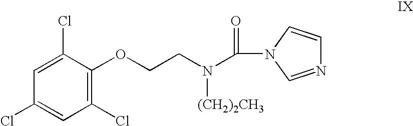
and
(9) tetraconazole of the formula X 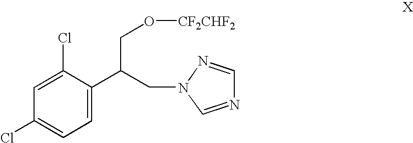
and
(10) triflumizole of the formula XI 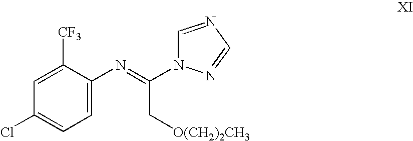
and
(11) flutriafol of the formula XII 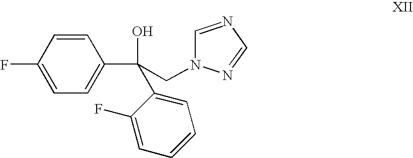
and
(12) myclobutanil of the formula XIII 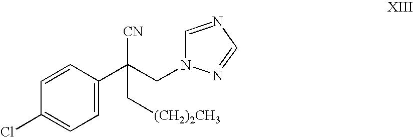
and
(13) penconazole of the formula XIV 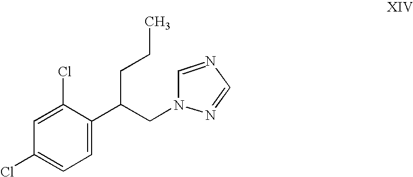
and
(14) simeconazole of the formula XV 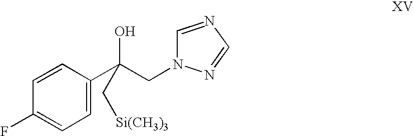
and
(15) ipconazole of the formula XVI 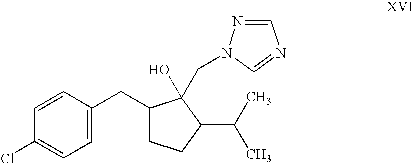
and
(16) triticonazole of the formula XVII 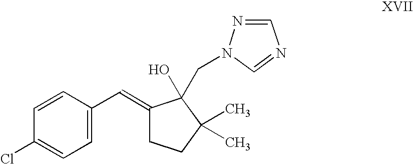
and
(17) prothioconazole of the formula XVIII 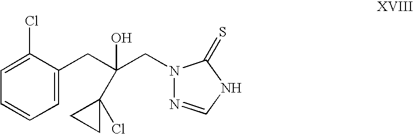
in a synergistically effective amount.

2. A fungicidal mixture as claimed in claim 1, wherein the azole derivative is selected from the group consisting of
(1) bromuconazole,
(3) dimiconazole,
(4) fenbuconazole,
(5) fluquinconazole,
(6) flusilazole,
(8) prochloraz,
(9) tetraconazole,
(10) triflumizole,
(11) flutriafol,
(12) myclobutanil,
(13) penconazole,
(14) simeconazole and
(17) prothioconazole.

3. A fungicidal mixture as claimed in claim 1, wherein the azole derivative is selected from the group consisting of
(2) difenoconazole,
(7) hexaconazole,
(15) ipconazole and
(16) triticonazole.

4. A fungicidal mixture as claimed in claim 1, wherein the azole derivative is selected from the group consisting of
(13) penconazole,
(14) simeconazole,
(15) ipconazole,
(16) triticonazole and
(17) prothioconazole.

5. A fungicidal mixture as claimed in claim 1, wherein the azole derivative is selected from the group consisting of
(13) penconazole,
(14) simeconazole and
(17) prothioconazole.

6. A fungicidal mixture as claimed in claim 1, wherein the weight ratio of the triazolopyrimidine of the formula I to the respective triazole of formulae II to XVIII is from 100:1 to 1:100.

7. A fungicidal composition, comprising a fungicidal mixture as claimed in claim 1 and a solid or liquid carrier.

8. A method for controlling rice-pathogenic harmful fungi, which comprises treating the harmful fungi, their habitat or the plants, seeds, soils, areas, materials or spaces to be kept free from them with the triazolopyrimidine of the formula I as set forth in claim 1 and azoles of the formulae II to XVIII as set forth in claim 1.

9. A method for controlling phytopathogenic harmful fungi from the class of the Oomycetes, which comprises treating the harmful fungi, their habitat or the plants, seeds, soils, areas, materials or spaces to be kept free from them with the triazolopyrimidine of the formula I as set forth in claim 1 and azoles of the formulae II to XVIII as set forth in claim 1.

10. A method as claimed in claim 8, wherein the compound of the formula I as set forth in claim 1 and at least one compound of formulae II to XVIII as set forth in claim 1 are applied simultaneously, that is jointly or separately, or in succession.

11. A method as claimed in claim 8, wherein the fungicidal mixture or the compound of the formula I and at least one compound of formulae II to XVIII as set forth in claim 1 is/are applied in an amount of from 5 to 2000 g/ha.

12. Seed, comprising the mixture as claimed in claim 1 in an amount of from 1 to 1000 g/100 kg.

13. The use of the compounds I and II to XVIII as set forth in claim 1 for preparing a fungicidal comosition as claimed in claim 7.
